(19) United States
(12) Patent Application Publication
(10) Pub. No.: US 2009/0185708 A1
(43) Pub. Date: Jul. 23, 2009

(54) System and method for controlling the speed of a rotating speaker

(76) Inventor: Warren Brunsting, Darien, IL (US)

Correspondence Address: MARTIN E. JERISAT, SUITE 3300, 10 S. LASALLE STREET, CHICAGO, IL, 60603, US

(21) Appl. No.: 12/009,286

(22) Filed: Jan. 18, 2008

(51) Int. Cl. H04R 1/02

(52) U.S. Cl. 381/387

(57) ABSTRACT

A method for using a device that has a user interface to control the speed of a rotating sound speaker, which has rotating rotors, between predetermined speeds, is disclosed herein. The method includes the steps of providing a user input through the user interface, adjusting some parameters associated with the device in response to the user input, generating a power output, processing the output through a control circuit and continuously varying the speeds of the rotors accordingly. A rotating speaker system is also disclosed herein. The system includes a rotating speaker and a device that controls the speed of the rotating rotors of the speaker between predetermined speeds.

### BACKGROUND OF THE INVENTION

Certain Leslie® speakers are well known in the industry and music field. Famous rock bands and guitarists rocked and rolled on grinding and beautiful riffs coming from Leslie® speakers. Such bands and musicians include The Beatles, Eric Clapton, Stevie Ray Vaughn, Jim Peterik, and Pink Floyd.

Speakers are known that include motor control boards for controlling the movement of components in the speakers to modify the sound produced by musical instruments providing input to the speakers. As is known in the industry, a musician often fine tunes his music to generate various sound effects. This may be accomplished by varying the speed of rotors via a single, or dual, button foot switch so as not to interrupt the playing of the instrument. The switch may include buttons, such as a STOP button and a FAST/SLOW button. Though the industry is familiar with switches that allow some varying of output, the industry is in need to a switch that allows greater variation and control speed. The industry is also in need of systems and methods to allow a musician to maintain the rotors at a desired sweet spot. There is a need for an improved switch that will allow greater variation and control of rotors without disruption during the play of an instrument. Thus, a heretofore unaddressed need exist in the industry to address the aforementioned deficiencies and inadequacies.

### SUMMARY OF THE INVENTION

The objects mentioned above, as well as other objects, are solved by the present invention, which overcomes disadvantages while providing new advantages not previously obtainable in the prior art.

In a preferred embodiment, a method for using a device, that may include a user interface, to control the speed of a rotating speaker between pre-set minimum and maximum speeds is provided. The sound speaker may include an upper rotating horn connected to a lower drum through a crossover network. The method may include the steps of providing a user input through the user interface of the device, adjusting one or more parameters associated with the device in response to the user input, generating an output according to these parameters, processing the generated output through a circuit and continuously varying the speed of the rotors according to the output. These parameters may include the amount of resistance in a potentiometer that may be coupled to the device or the amount of light passing through a photocell that may be coupled to the device and so forth. Adjusting one or more of these parameters may generate a power output that may be transmitted to a circuit via a variety of means, such as an electromagnetic transmission, a radio frequency transmission, an infrared transmission, a microwave transmission, an acoustic transmission, a wire transmission, a cable transmission, a wireless, a network transmission and so forth. The circuit may process and amplify the power output to control speeds of the rotors of the speaker.

The invention also includes a speaker system that has a rotating speaker, that includes a horn speaker that has a horn rotor and connected to a drum speaker that has a drum rotor, and a device that has a user interface to continuously control the speed of the rotors between pre-set minimum and maximum speeds of the rotors. The device may be a speed pedal, a slider, a knob, a switch, a variable selector or a wheel and so forth. The device may include a user interface configured to receive a user input. The device may be configured to adjust one or more parameters associated with the device in response to the user input. The change in the parameters may generate output that may be transmitted to a circuit. The circuit may process the output and may vary the speeds of the rotors accordingly.

Other systems, methods, features, and advantages of the present invention will be, or will become, apparent to one having ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The novel features which are characteristic of the invention are set forth in the appended claims. The invention itself however, together with further objects and attendant advantages thereof, will be best understood by reference to the following description taken in connection with the accompanying drawings, in which:

FIG. 1 is side view of a preferred embodiment of the device associated with a potentiometer showing the position of the device at a slow speed position;

FIG. 2 is a top view of the device;

FIG. 3 is a side view of the device associated with a potentiometer showing the position of the device at a fast speed position;

FIG. 4 is side view of a preferred embodiment of the device associated with an optical device showing the position of the device at a slow speed position;

FIG. 5 is a top view of the device;

FIG. 6 is a side view of the device associated with an optical device showing the position of the device at a fast speed position;

FIG. 7 is schematic diagram of a speed control circuit according to the principles of the invention;

FIG. 8 is a block showing a musical instrument and the device connected to a rotating speaker having a speed control circuit; and

FIG. 9 is a block diagram illustrating a method for controlling the speed of a rotating speaker.

The components in the drawings are not necessarily to scale, emphasis instead being placed upon clearly illustrating the principles of the present invention. In the drawings, like reference numerals designate corresponding parts throughout several views.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

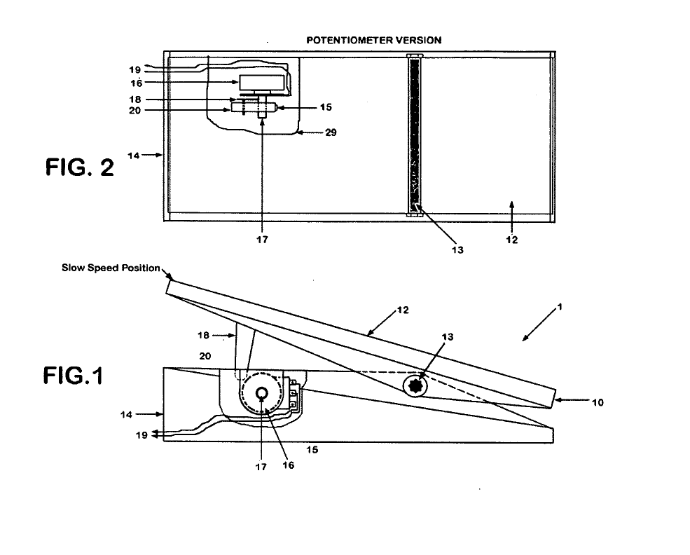

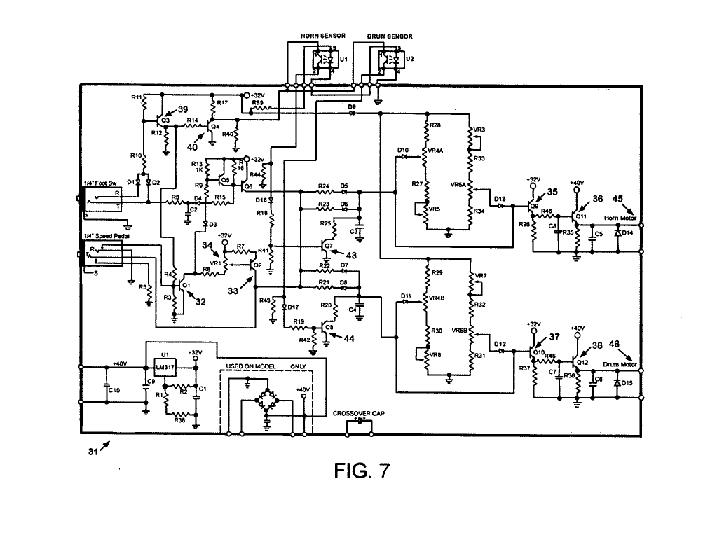

FIG. 1 is a side view of a device 1 according to the principles of the invention at a minimum or slow speed position. The device 1 may be a speed pedal, a slider, a knob, a switch, a variable selector or a wheel and so forth. One preferred embodiment is a speed pedal 10. The speed pedal 10 may include a user interface in the form of a pedal shoe 12. A user interface may include a variety of user input devices, such as buttons and adjustable controls, switches or other device that may be configured to receive a user input. Speed pedal 10 may include a pedal base 14 that may be connected to user interface 12 via a pivot shaft 13. User interface 12 may be configured to be responsive to a user input in a variety of methods. One method may include the use of a potentiometer 16. Potentiometer 16 may rotate around a shaft 17, which may engage shaft linkage 20. The position of shaft 17 may be fixed to shaft linkage 20 by means of a linkage adjustment screw 15. Shaft linkage 20 may be coupled to an actuating arm 18. When user interface 12 receives a user input, such as a press, one or more parameters, such as resistance of potentiometer 16, may change. User interface 12 may rotate around shaft 13 and applies pressure through actuating arm 18 to shaft linkage 20. Shaft 17 of potentiometer 16 may rotate until the resistance of potentiometer 16 reaches a pre-determined resistance. Linkage adjustment screw 15 may then be tightened to maintain the maximum resistance setting at a pre-determined level. A small current supplied by a control circuit 31, shown in FIG. 7, may cause a low voltage output to be generated and may be developed across any associated output.

Alternative embodiment may include a potentiometer that has a small toothed gear that may be coupled to a potentiometer's shaft instead of shaft linkage 20. Actuating arm 18 may include a toothed surface that may engage the toothed gear on the potentiometer's shaft. When user interface 12 receives a user input, the toothed actuating arm may cause the potentiometer's shaft to rotate and thereby change its electrical resistance.

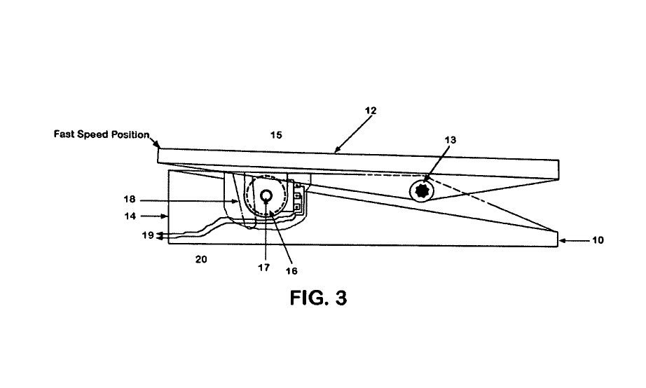

FIG. 2 shows a top view of speed pedal 10 and a section cut 29 illustrates the top view of potentiometer 16. Potentiometer 16 may be rotate around shaft 17, which may be coupled to shaft linkage 20. Shaft linkage 20 may be connected to actuating arm 18. Output wires 19 may be provided to communicate generated output to other components.

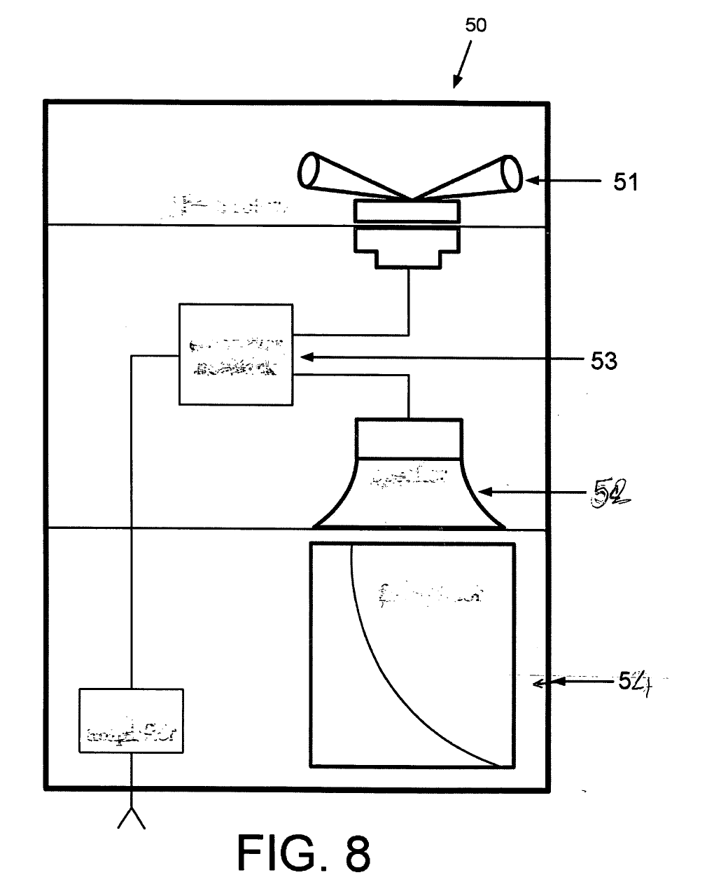

FIG. 3 shows a device 1 according to the principles of the invention, such as speed pedal 10, at a maximum or fast speed position. When speed pedal 10 receives a user input, user interface 12 may move in a downward direction. The action of actuating arm 18 and shaft linkage 20 may cause potentiometer shaft 17 to rotate. The rotation of potentiometer shaft 17 may adjust one or more parameters associated with speed pedal 10, such as resistance measured at output wires 19, to increase to high value, may be 9,000 ohms or higher. The maximum value of potentiometer 16 may be set beforehand by the manufacturer of speed pedal 10. As potentiometer shaft 17 rotates, one or more of the parameters, such as the resistance measured at output wires 19 may increase in response to a user input. The increase in resistance may generate an output, such as a voltage, across output wires 19. The output voltage may be transmitted in a variety of ways, wired or wireless, to control circuit 31 to control speed of upper horn rotor 51 and lower drum rotor 54 (shown in FIG. 8). Thus, a user may control speeds of rotors 51 and 54 via a user input on user interface 12.

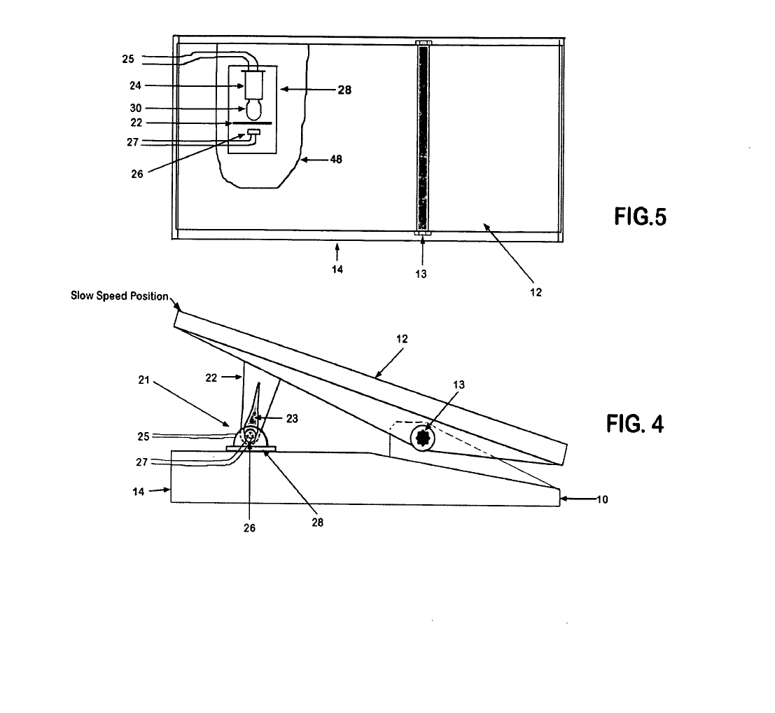

FIG. 4 shows another embodiment of device 1 according to the principles of the invention. A speed pedal 10 may include user interface 12, which may be configured to be responsive to a user input, in the form of a pressure. One or more parameters associated with speed pedal 10 may be adjusted, such as the amount of lights received through optic sensor 21, in response to a user input. Optic sensor 21 may include lamp 30 and may be housed inside a housing 28. Housing 28 may also include photocell 26, which may be separated from lamp 30 by a light shutter 22. When speed pedal 10 is in its upright position or minimum pre-set speed, the amount of light passing through open shutter area 23 is at it maximum value and so resistance of photocell 26 may be at lowest value. The low resistance may generate lower voltage output at photocell wires 27. The low voltage may be transmitted to circuit 31 via wired, wireless, electromagnetic and other ways. The low voltage may be applied to control or influence an upper horn rotor control signal 45 and a lower drum rotor control signal 46 to rotate upper rotating horn rotor 51 and lower drum rotor 54 at their lowest speed.

FIG. 5 shows a top view of speed pedal 10 and shows a section cut 48. Section cut 48 shows housing 24 including lamp 30 and photocell 26 that may be separated by light shutter 22. Output wires 27 and input wires 25 maybe provided accordingly.

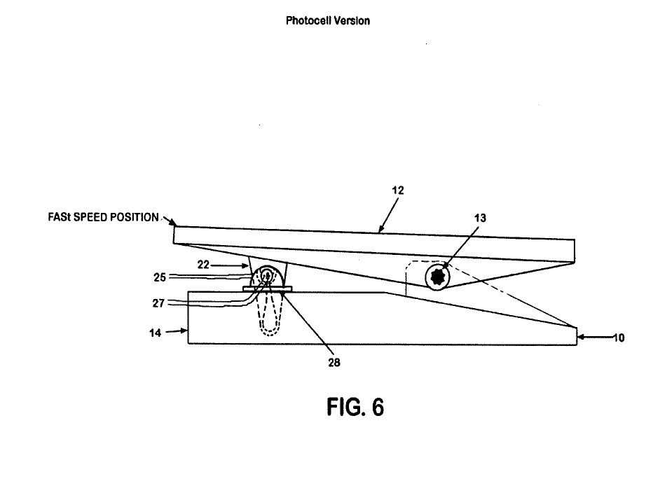

FIG. 6 shows speed pedal 10 at a maximum pre-set speed. As user interface 12 responds to a user input, light shutter 22 may allow less light to be passed through open shutter 23. As the amount of light decreases, the resistance of photocell 26 may increase and may increase the voltage output measured at photocell wires 27. The power output may be transmitted to circuit 31. Circuit 31 may process and amplify the output and apply it to rotors 51 and 54. Rotors 51 and 54 may continuously vary their speeds accordingly.

FIG. 7 shows a circuit 31 according to the principles of the invention. When device 1 is connected to circuit 31, transistor stage 32 may be activated and may turn on transistor 33 to supply a small current to a speed pedal variable resistor 34. The current may cause a voltage to appear on potentiometer wires 19 or photocell wires 27 when connected to potentiometer 16 or photocell 26. The voltage may vary depending on the user input. The maximum speed of rotors 51 and 54 may occur when the resistance of speed pedal 10 is at its maximum value resulting in the highest output voltage. When the user input is minimum, the resistance of speed pedal 10 may be at its minimum value and that may cause the voltage across output wires 10 and 27 to be at a minimum value. The low voltage may cause rotors 51 and 54 to run at their minimum speed. The voltage may be amplified by transistors 35 and 36 to generate horn motor control signal 45 for upper horn rotor 51 and may also be amplified by transistors 37 and 38 to generate drum motor control signal 46 for lower drum rotor 54.

FIG. 8 shows a traditional rotating sound speaker 50, such as Leslie® speaker model 122A. Speaker 50 has an upper rotating horn rotor 51, which may be connected, by a crossover network 53, to a lower drum rotor 54, and may include speaker 52. Rotor 51 and rotor 54 may include a DC motor or any other type of motors.

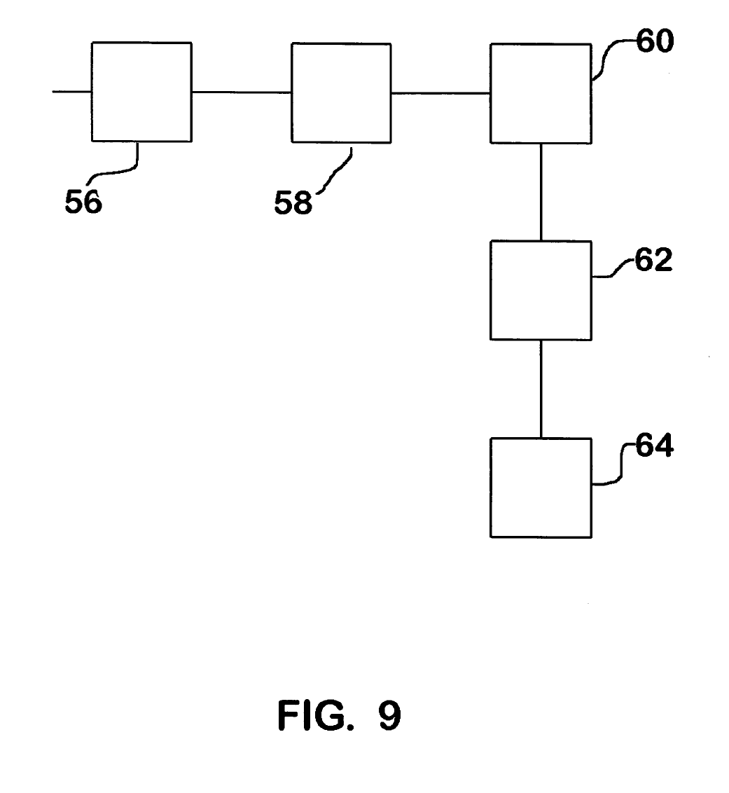

FIG. 9 is a block diagram illustrating a method for controlling the speed of a rotating speaker, such as speaker 50 in FIG. 8. Speaker 50 may be controlled from pre-set minimum to maximum speeds. The method may include a step of receiving a signal 56, for example receiving a signal from a device 1 that may have a user interface 12, for example speed pedal 10, receiving a user input. User interface may include buttons and adjustable controls, switches, mechanical, optical, electromechanical or acoustic elements that may be configured to receive a user input. A user input may be mechanical, acoustic, optical, electromagnetic, thermal, and so forth.

Once the user input is received by device 1, the step of adjusting parameter(s) 58 associated with device 1 may occur in response to the specific user input. If the user input is mechanical, changes in resistivity of a potentiometer that may be associated with device 1 may occur; if the user input is optical, changes in quantity of light received by an optical device that may be associated with device 1 may occur, and so forth.

The method may also include the step of outputting 60 changes in one or more parameters. The output may be in the form of power, voltage, thermal, electromagnetic, or any other forms. The output may be a direct result of adjusting parameter(s) 58. The output may be a voltage generated as a result of changes in the electrical, optical, thermal or acoustic properties of device 1. The output may also include other forms of power.

The method may also include processing the output 62, which may be performed by speed control circuit 31. Circuit 31 may include discrete circuitry such as passive or active analog components including resistors, capacitors, inductors, transistors, operational amplifiers, and so forth, as well as discrete digital components and so forth. Circuit 31 may process the output in a variety of ways, such as developing and amplifying the power, and so forth.

The method may also include the step of providing a rotor control signal 64. The power may be transmitted to speaker rotors 51 and 54 to control the rotation speed in a continuum between slow and fast speeds.

The above description is not intended to limit the meaning of the words used in the following claim that define the invention. For example while preferred embodiments involving devices adapted to control speed of rotating speakers and method of using these devices have been described above, persons of ordinary skill in the art will understand that a variety of other designs still falling within the scope of the following claims may be envisioned and used. It is contemplated that future modifications in structure, function, or result will exist that are not substantial changes and that all such insubstantial changes in what is claimed are intended to be covered by the claims.

1. A method for using a device having a user interface to continuously control the speed of a rotating speaker, the speaker includes a rotating horn, a rotating drum, wherein the rotating horn is operatively connected to the rotating drum, the method comprising the steps of:
a. providing a user input via the user interface;
b. adjusting one or more parameters associated with the device in response to the user input;
c. generating an output according to the one or more parameters;
d. processing the output via a control circuit; and
e. varying the speed of the rotors in a continuum according to the output.

2. The method of claim 1 further including the step of providing the user input via at least one adjustable user operated device so as to provide at least one adjustable user input.

3. The method of claim 1 further including the step of providing the user input via at least one of a pedal, a slider, a knob, a switch, a variable selector and a wheel.

4. The method of claim 1 wherein the step of adjusting one or more parameters includes the step of varying a resistance in response to the user input.

5. The method of claim 1 wherein the step of adjusting one or more parameters includes the step of varying the amount of light receivable in response to the user input.

6. The method of claim 1 wherein the step of generating an output according to one or more of the parameters includes the step of generating a current output.

7. The method of claim 1 wherein the step of processing the output via a circuit includes the steps of developing and amplifying a voltage across the circuit and applying the voltage to the rotors of the speaker.

8. The method of claim 1 further including the step of continuously changing the user input to vary the speed of the rotors of the speakers.

9. The method of claim 1 further including the step of transmitting the generated output to the circuit via at least one of an electromagnetic transmission, a radio frequency transmission, an infrared transmission, a microwave transmission, an acoustic transmission, a wire transmission, a cable transmission, and a network transmission.

10. A speaker system comprising:
a. a rotating speaker including a rotating horn and operatively connected to a rotating drum; and
b. a device to control the speed of the rotors in a continuum, the device includes a user interface configured to receive a user input, wherein the device is adapted to be associated with the rotating speaker.

11. The speaker system of claim 10 wherein the device is configured to adjust one or more parameters in response to the user input.

12. The speaker system of claim 11 wherein the one or more of the adjustable parameters is the amount of resistance associated with the device.

13. The speaker system of claim 11 wherein the one or more of the adjustable parameters is the amount of light receivable associated with the device.

14. The speaker system of claim 11 wherein the device is configured to generate a power output according to the one or more of the adjustable parameters.

15. The speaker system of claim 14 wherein the device is configured to transmit the generated output to a circuit via at least one of an electromagnetic transmission, a radio frequency transmission, an infrared transmission, a microwave transmission, an acoustic transmission, a wire transmission, a cable transmission, and a network transmission.

16. The speaker system of claim 15 wherein the generated output is processed via the circuit to control the speed of the rotors.

17. A speed pedal adapted to be associated with a rotating sound speaker for controlling speed of the rotating speaker between pre-set speed values, the speaker including a rotating horn, a rotating drum, wherein the rotating horn is operatively connected to the rotating drum, the speed pedal comprising:
a. a user interface configured to receive a user input; and
b. a pedal base pivotally coupled to the user interface.

18. The speed pedal of claim 17 wherein the pedal base includes a potentiometer coupled to the user interface to vary resistance of the potentiometer in response to the user input and to generate power output accordingly.

19. The speed pedal of claim 17 wherein the pedal base includes an optic device configured to generate a power output in response to the user input.

20. The speed pedal of claim 18 wherein the pedal base is adapted to be associated with a circuit for transmitting the generated power output to the circuit.

21. (canceled)
